(19) United States
(12) Patent Application Publication
(10) Pub. No.: US 2004/0154146 A1
(43) Pub. Date: Aug. 12, 2004

(54) Web spreader roll and methods for spreading webs of material

(76) Inventor: Paul R. Pruitt JR., Inman, SC (US)

Correspondence Address: Terry T. Moyer, P.O. Box 1927, Spartanburg, SC, 29304, US

(21) Appl. No.: 09/859,958

(22) Filed: May 17, 2001

(51) Int. Cl. B25F 5/02; F16C 13/00

(52) U.S. Cl. 26/99; 492/27; 492/58

(57) ABSTRACT

The invention relates to rolls for use in spreading webs and minimizing the formation of wrinkles therein. The roll has a diameter in its central region that is greater than the diameter proximate its end portions. The diameter can taper straight from the central portion to the ends, can parabolically taper from the central portion to the ends, can utilize a combination of a parabolic shape and straight taper, or other profile variations.

### FIELD OF THE INVENTION

The invention generally relates to a roll for use in the spreading of a web of material as it is conveyed across a distance. In particular, the invention is directed to a roll adapted to efficiently spread a moving web of material as it is transported through a processing operation without causing permanent deformation of the web.

### BACKGROUND

In the manufacture and processing of webs such as textile fabrics and the like, it is often important that the web be spread out in order it can be evenly processed, treated, cut or otherwise handled. For example, many fabric dyeing operations involve the gathering of the fabric into rope form during the process, only to require immediate flattening of the fabric for subsequent processing operations such as drying and heatsetting. As will be appreciated by those of ordinary skill in the art, the presence of wrinkles and the like during certain operations can lead to defects in the material. Therefore, it is often critical that the material be spread apart fully to avoid the introduction of defects.

Speed is generally considered to be important in most manufacturing operations, since economic advantages can be achieved with greater manufacturing speeds. By the same token, material webs generally can only withstand certain levels of forces. Therefore, it is generally important that the spreading be performed using forces which do not damage or adversely impact the material. As a result, operating speeds often need to be controlled at lower than optimal levels in order to ensure complete spreading of the material without adverse impact to the material being processed.

Current methods for spreading webs such as textile fabrics typically utilize a bowed roll which is covered with a plurality of rings that rotate around the bowed roll. The rings are in turn generally either individually or collectively covered with one or more rubber covers. Furthermore, the rotation of the rings about the roll is generally facilitated through the use of bearings or other mechanical facilitators, and lubricating media such as oil. Examples of such rolls are described in U.S. Pat. Nos. 6,042,525 and 5,735,783 to Rajaniemi and Joensuu, respectively. While performing well in many instances, one disadvantage associated with the conventional bow rolls is that the rubber covering can tend to crack. Not only can the cracked rubber cover damage the fabric, but the lubricants can escape from the inside of the roll and soil the fabric being processed. Because the processes are generally being performed at relatively high speeds, a large quantity of fabric can be damaged or soiled before an operator may be alerted to the cracked roll cover. Furthermore, once the roll cover breach is detected, it takes an undesirably long period of time to remove the roll and repair the cover.

Another issue associated with these conventional rolls is that the degree to which they affect fabric spreading is generally dependent on the amount of bow in the roll. In other words, where it is desired to spread a material more vigorously, the roll will generally be bowed to have a greater degree of arc. In the event that the amount of arc or bow used is too great for the particular fabric being processed, the fabric can be stretched in the center, which can lead to off-quality. In addition, the conventional bow rolls tend to be relatively expensive to purchase, repair and replace.

### SUMMARY

The present invention achieves consistent spreading of webs of material without the disadvantages often associated with prior spreading techniques. In addition, the invention can be readily utilized and retrofit into most existing web-conveying apparatus, without the need for expensive equipment conversion.

The roll structure described herein desirably is generally rod-shaped, with a diameter that varies along the length of the rod. More specifically, the diameter of the roll is desirably larger in a central region of the roll than proximate the roll end portions. The diameter can taper from the larger diameter portions to the smaller diameter regions in a variety of ways, including but not limited to parabolic tapering, straight line tapering, or combinations thereof. For example, in one aspect of the invention, the roll has straight line taper from its central portion, which has the greatest diameter toward its end portions. In another embodiment of the invention, the roll is tapered so as to form a parabolic shaped roll surface. In yet another embodiment of the invention, a certain length of the central portion of the roll has a parabolic taper, while each side of the roll begins a straight line taper toward the roll ends.

The roll of the present invention can be used on essentially any apparatus where web spreading would be desired including but not limited to any apparatus for processing or transporting textile materials such as woven, knit and nonwoven fabrics, paper, fiber batts, and the like. The roll also desirably includes roll supports by which it is supported in the apparatus. For example, small rods, etc. can be provided to extend outwardly from each end of the roll to support it within an apparatus. These can be formed integrally with the roll, such as by chamfering or otherwise shaping the roll ends. These roll supports can be inserted in an apparatus in the same manner as a conventional bow roll. Alternatively, supplemental roll support means can be provided to enable the roll to be supported in its operative position on an apparatus.

### BRIEF DESCRIPTION OF THE DRAWINGS

FIG. 1 is a perspective view of a portion of an apparatus incorporating a roll according to the invention as the center roll in the roll arrangement;

FIG. 2 is a plan view of an alternative embodiment of a roll according to the invention;

FIG. 3 is a plan view of another alternative embodiment of a roll according to the invention;

FIG. 4 is a cross-sectional view of an apparatus utilizing a roll according to the invention as the center roll; and

FIG. 5 is a cross-sectional view of an apparatus utilizing a roll according to the invention as the center roll, with the roll being positioned in an alternative orientation as compared with that of FIG. 4.

### DETAILED DESCRIPTION

In the following detailed description of the invention, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

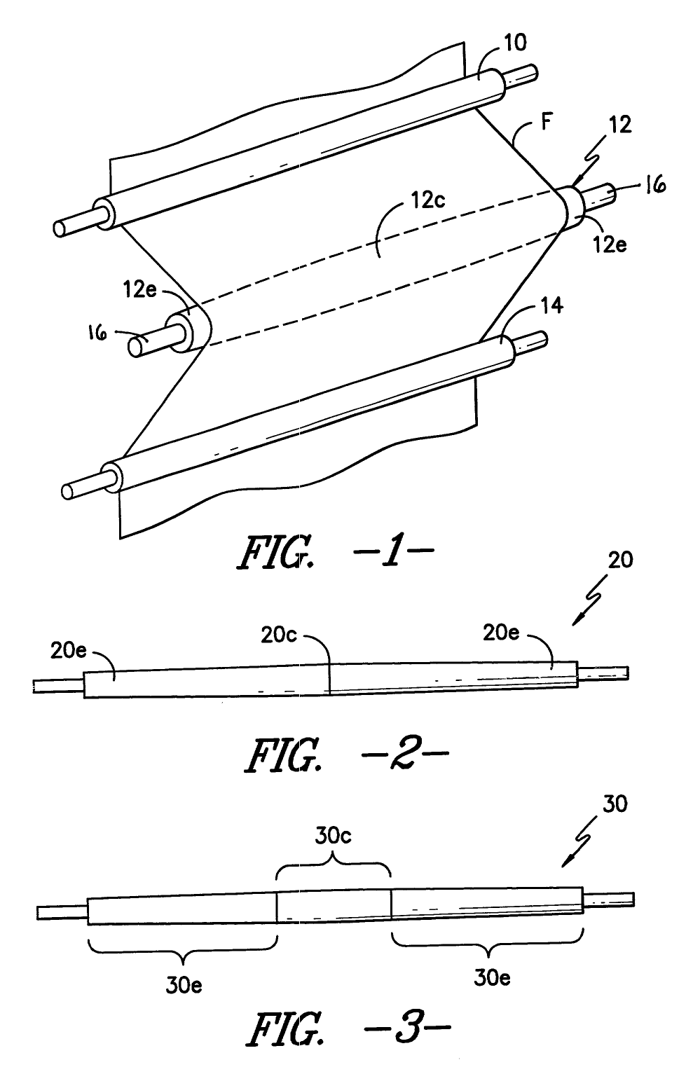

With reference to the drawings, FIG. 1 is a perspective environmental view of a roll according to the invention, illustrating one arrangement in which it could be used. As illustrated, the apparatus is arranged so that fabric F passes behind a first roll 10, over the web spreader roll 12, and behind a third roll 14. As illustrated, the first and third rolls 10 and 14, respectively, are conventional type rolls having a consistent diameter along the roll length. In contrast, the roll 12 of the instant invention has a diameter that varies along the length of the roll. In particular, the diameter of the roll 12 is greater proximate a central portion 12c of the roll than proximate the end portions 12e of the roll.

The multidimensional roll of the instant invention can be shaped in any of a variety of ways. Preferably a central portion of the roll and more preferably, the center of the roll is the region of the roll having the largest diameter.

The transition of diameter from the larger diameter central portion 12c to the smaller diameter end potions 12e can be achieved in any of a variety of manners including but not limited to a straight line, a parabolic shape, or combinations thereof. For example, the roll 12 in FIG. 1 has a parabolic contour, while the roll 20 in FIG. 2 has a straight line taper from a largest diameter center point 20c to the smaller ends 20e.

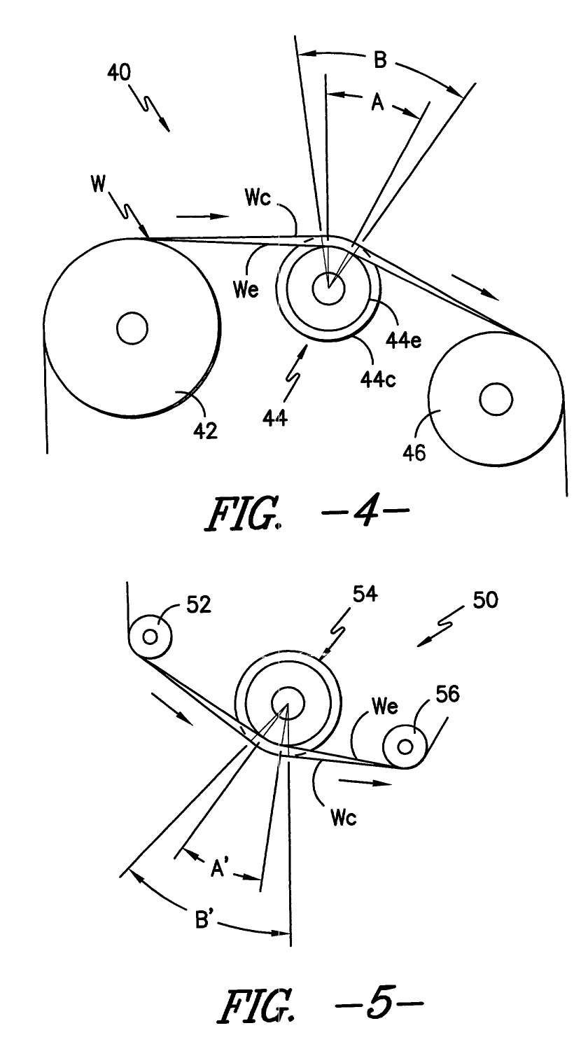

As noted, combination shapes can also be used within the scope of the instant invention. For example, one such combination profile is illustrated in roll 30 of FIG. 3, where a central portion 30c has a parabolic contour, which in turn transitions to a straight-line taper as shown at 30e. However, other shapes and combinations are also contemplated within the scope of the invention. Where a combination taper contour is provided, the relative proportions of the variously shaped roll sections can be selected to achieve optimum spreading for the particular web material being processed and the particular machinery on which the roll is used. For example, it has been found that for a 78-inch long roll adapted to spread textile fabrics on an 80-inch preparation machine, a parabolically-shaped central portion 30c having a 5 inch maximum diameter which is 18 inches long, with 30-inch straight-line tapered portions 30e (with a minimum diameter of 4 inches) on each side provides a good degree of fabric spreading. However, other diameters, profile combinations and relative profile dimensions are contemplated within the scope of the invention.

Similarly, varying degrees of crown (i.e. the difference in radius at the region of largest diameter from the radius at the region of smallest diameter) can be used to achieve the optimum spreading. For examples, crowns of about ¼ inch to about 1 inch on a 78-inch roll would be expected to perform well in the spreading of a textile fabric, with ½ inch crown having been found to perform particularly well. In other words, the difference in radius between the thicker and thinner roll portions is about 0.3—about 1.2% of the length of the roll (i.e. ¼/78 to 1/78).

Another variable that can be used with the roll of the invention is illustrated in FIGS. 4 and 5, with that being the amount the web of material wraps around the spreader roll. The amount of wrap can be readily and easily controlled by biasing the spreader roll toward the web to a greater extent, to force the web of material out of its straight line path between adjacent rolls 42, 46 (FIG. 4) and 52, 56 (FIG. 5), to thereby wrap the web W around the spreader roll 44 (FIG. 4), 54 (FIG. 5). Because of the difference in diameter of the roll, the degree of wrap between the central portion of the web will vary from that of the edge portions, thereby enabling the operator to selectively control the intensity of fabric spreading.

For example, in FIG. 4, web W is being conveyed between rolls 42 and 46 in the direction illustrated by the arrows. In this case, the web W was 68 inches in width and was conveyed at about 1-3 pounds/linear inch of tension. Spreader roll 44 is provided between the rolls 42 and 46, with the spreader roll being biased toward the web so as to cause the web to wrap around it. Because of the variation in diameter of the spreader roll (which in the illustration has a standard parabolic profile, and a half inch crown between the central portion and the end portions), the degree of wrap of the web is different at the central portion of the web (shown at Wc) than at the the end portions of the web (shown as We). The wrap angle at the ends of the web W is A, while the wrap angle at the center portion of the web is B. The difference in the wrap angles from the center of the web to the end portions can therefore be easily calculated by subtracting A from B. In one embodiment of the invention using the roll arrangement shown in FIG. 4 and the same roll described above, the center portion had a wrap angle A of 24 degrees and the end portions had a wrap angle B of 30 degrees. Therefore, the 78 inch, parabolically-profiled roll with the half-inch crown had a difference in wrap angle from center to sides of 6 degrees (i.e. 30 degrees minus 24 degrees.) The wrap angles used can be varied as described above. For most textile fabric spreading, it is believed that a difference in wrap angle varying from about 3 degrees to about 15 degrees will provide desirable results. Also, the tension at which the web W is conveyed can be adjusted to affect the amount of spreading.

Similarly, the arrangement in FIG. 5, which has the spreader roll positioned above the web W to be spread, forms similar differences in relative wrap between the center and sides of the web. In the FIG. 5 arrangement, the web W passes over a sequence of rolls 52, 54 and 56 as it is conveyed in the direction indicated by the arrows. Again, the web W was 68 inches wide and was conveyed at 1-43 pounds/linear inch of tension. In that embodiment, the roll 54 is a parabolically-profiled spreader roll of the same variety illustrated in FIG. 4. The edge portions of the web We form a wrap angle of A′, while the center portion of the web Wc forms a wrap angle of B′. Again, the difference in the relative wrap angles can be calculated by subtracting A′ from B′. In one embodiment of the invention having the same arrangement illustrated in FIG. 5 and designed to spread a textile fabric, wrap angle A′ was 22 degrees while angle B′ was 31 degrees, for a relative difference of 9 degrees. As will be appreciated by those of ordinary skill in the art, different relative proportions, wrap angles, etc. can be used within the scope of the invention, with the optimal relationships being selected to correspond to the equipment being used, the orientation of the rolls, and the type of web material being processed.

The roll of the instant invention can be utilized in a variety of apparatus where the feature of web spreading would be desirable. For example, the roll could be used in the production and/or processing of textile materials, bats or webs of fibers, films, paper, and other types of webs.

Preferably, the roll is designed so that it can be readily utilized on conventional machines without significant retrofitting. To this end, the spreader roll desirably includes supports for supporting the roll on the machine. For example, the roll can be chamfered at its ends to integrally form roll supports, such as those shown at 16 in FIG. 1. Alternatively, other types of roll support could be provided within the scope of the invention. The spreader roll can therefore simply be substituted where a conventional bow roll would typically have been used, without the need for significant retrofitting of the machine.

The roll can be made from any material desired, or combinations of materials. For example, in many applications, metals and/or polymers that hold their dimension despite being exposed to elevated temperatures, moisture, chemicals, etc. would be desirable. Stainless steel has been found to perform particularly well in the instant invention, although other materials such as carbon steel, aluminum, polymeric materials and the like, and combinations thereof can be used.

The surface of the roll is desirably smooth, in order that it will not damage the web that it is being used to spread. However, in particular applications it may be found to be desirable to reduce or increase the frictional characteristics of the roll (in particular, to reduce friction.) In such situations, it is within the scope of the invention to shape (e.g. through stipples or the like) or apply some form of covering or coating to the roll, in order to provide the particular frictional characteristics desired. Since it will typically be desired for the roll to rotate as the web is traveling over it, it will generally be desirable to have a slight amount of friction between the roll and the web, in order to facilitate roll turning and web spreading.

The device of the invention enables significant flexibility in processing. For example, the roil surface, length of roll, amount of crown, amount of wrap, and running tension can all be selected to optimize the spreading for the particular web on the particular processing apparatus to which it is applied.

In the specification there has been set forth a preferred embodiment of the invention, and although specific terms are employed, they are used in a generic and descriptive sense only and not for purpose of limitation

I claim:

1. A spreader roll having a central portion and first and second end portions that are adapted to contact a web of material, wherein said central portion has a diameter that is larger than that of said end portions.

2. A spreader roll according to claim 1, wherein the roll defines a shaped profile, with said profile tapering from said central portion to said end portions.

3. A spreader roll according to claim 2, wherein said shaped profile comprises a straight line taper.

4. A spreader roll according to claim 2, wherein said shaped profile comprises a parabolically-shaped taper.

5. A spreader roll according to claim 2, wherein said shaped profile comprises a straight line taper and a parabolically-shaped taper.

6. A spreader roll according to claim 1, wherein said roll includes at least one roll support.

7. A spreader roll according to claim 6, wherein said roll includes at least one roll support proximate each of its end portions.

8. A spreader roll according to claim 6, wherein said roll includes an integrally-formed roll support on each of its end portions.

9. A spreader roll according to claim 1, wherein said central portion has a crown of about ¼ inch to about 1 inch.

10. A spreader roll according to claim 9, wherein said roll is about 78 inches in length.

11. A spreader roll according to claim 9, wherein said crown is about 0.3 to about 1.2% of the length of the roll.

12. A spreader roll according to claim 1, wherein said roll is manufactured from a material selected from the group consisting of stainless steel, carbon steel, aluminum, polymeric materials, and combinations thereof.

13. An apparatus for processing a web of material comprising:
means for conveying a web of material along a path;
a spreader roll having a central portion and first and second end portions for contacting said web and spreading said web into a planar orientation while the web is moving along said path, wherein said central portion has a diameter which is larger than the diameter of said end portions.

14. An apparatus according to Claim 13, wherein said spreader roll defines straight tapers from said central portion to said first and second end portions.

15. An apparatus according to claim 13, wherein said spreader roll defines a parabolic taper.

16. An apparatus according to claim 13, wherein said spreader roll defines a profile which is a combination of multiple taper shapes.

17. An apparatus according to claim 16, wherein said spreader roll defines a profile having a parabolic shape proximate the central portion of the roll and a straight line shape proximate said end portions.

18. An apparatus according to claim 17, wherein said parabolic shape comprises at least about 20% of the overall length of said spreader roll.

19. An apparatus according to claim 13, wherein said spreader roll comprises integrally-formed roll supports.

20. An apparatus according to claim 13, wherein said spreader roll comprises stainless steel.

21. A device for spreading a web of material comprising:
a single roll having a central portion and first and second end portions, wherein said central portion of said roll has a diameter which is greater than the diameter of the roll end portions.

22. A device according to claim 21, wherein a straight taper is formed from the central portion toward the end portions of the roll.

23. A device according to claim 21, wherein a parabolic taper is formed on said roll.

24. A device according to claim 21, wherein said central portion and first and second end portions define a working face of the roll, and said central portion has a parabolically-shaped profile which is at least about 20% of the overall length of the working face of the roll.

25. A device according to claim 21, wherein the central portion has a contour which is different from that of adjacent portions of the roll.

26. A device according to claim 25, wherein the central portion has a parabolically-shaped profile and adjacent portions of the roll have a straight line taper.

27. A method of spreading a web of material as it is conveyed along a path comprising the step of:
positioning a roll having a diameter that varies along its length such that it extends substantially perpendicular to the direction of web travel and contacts said web as it is conveyed along its path, to thereby provide varying degrees of wrap angle of the web about the roll across the web width.

28. A method according to claim 27, wherein the difference in angle of wrap at a central portion of the web and at end portions of the web is about 3 degrees to about 15 degrees.
